(19) United States
(12) Patent Application Publication
(10) Pub. No.: US 2011/0301928 A1
(43) Pub. Date: Dec. 8, 2011

(54) METHOD AND SYSTEM FOR ENGINEERING AN AUTOMATION OF AT LEAST PART OF A TECHNICAL INSTALLATION

(76) Inventor: Bernhard Iffländer, Weiden (DE)

(21) Appl. No.: 13/201,972

(22) PCT Filed: Nov. 30, 2009
(86) PCT No.: PCT/EP2009/066025

§ 371 Date: Aug. 17, 2011

(30) Foreign Application Priority Data
Feb. 17, 2009 (DE) 1020090092935

(51) Int. Cl. G06G 7/48

(52) U.S. Cl. 703/6

(57) ABSTRACT

In a method and a system for engineering an automation of at least part of a technical installation having a quantity N of objects that can be automated, data transfer between at least one development tool (1, 2), at least one test tool (3), and at least one simulation tool (4) is thereby performed by at least one interface.

### CROSS-REFERENCE TO RELATED APPLICATIONS

This application is a U.S. National Stage Application of International Application No. PCT/EP2009/066025 filed Nov. 30, 2009, which designates the United States of America, and claims priority to German Application No. 10 2009 009 293.5 filed Feb. 17, 2009, the contents of which are hereby incorporated by reference in their entirety.

### TECHNICAL FIELD

The invention relates to a method and a system for engineering an automation of at least part of a technical installation having a number N of objects which can be automated.

### BACKGROUND

In order to engineer an automation of part of a technical installation or of a technical installation as a whole, the objects which can be automated in the technical installation are usually determined and their structure is detected in a first step using one or more development tools.

In this case, a technical installation is understood as meaning an amalgamation of different units which together fulfill a particular technical purpose, for example a power plant, a papermaking machine, a printing machine, a continuous casting installation, a rolling train and the like.

In this case, an object which can be automated is understood as meaning, for example, an individual unit of the installation, such as a motor, a valve, a furnace, a cooling device and the like, or else a selection of particular units of the installation which are more closely related. Such a selection of units may relate to a drying group of a papermaking machine, the cooling section of a continuous casting installation and the like, for example.

The object data needed for the automation are determined in a second step using the same development tool or a further, separate development tool. In this case, in addition to particular properties of the objects, such as their color, installation location etc., their requirements, for example in the form of performance data, behaviors, control and regulating parameters etc., are also determined and associated with the respective object.

One known development tool for detecting and defining the requirements is, for example, Telelogic® Doors® from IBM.

A development tool for optimizing processing from Siemens AG makes it possible to carry out the first and second steps on the basis of a single development tool.

In order to carry out the automation, at least one control and regulating unit which is provided on the installation, at least partially processes the object data and accordingly implements the latter in the installation or the corresponding installation part is programmed accordingly.

In order to be able to determine whether the engineering of the automation was successful, test conditions are determined in a separate test tool and at least one test is simulated under the test conditions in a simulation tool.

A known test tool is offered by IBM under the name Rational. A structure of software objects is described in this tool.

The simulated test is used to check and, if necessary, optimize the correctness or applicability of the object data and the function of the control and regulating routines.

The simulation tool generates signals for possible events and scenarios which could occur during installation operation, even under extreme conditions. A simulation tool is known under the name SIMIT from Siemens AG, for example.

The simulated test results obtained in one or more simulated tests and individual data obtained are often manually acquired, evaluated and manually documented, for example in a simulation protocol, where possible weak points of the automation become noticeable. Such a simulation protocol generally comprises detailed statements and an overview of the simulated tests which have been carried out, etc.

Separate development tools, test tools and simulation tools are therefore used to engineer the automation of a technical installation. In this case, it is necessary to input data, which have already been manually input to a development tool for example or have been generated using a development tool, to a test tool and also to a simulation tool. Furthermore, the test results from simulated tests, which are determined using a simulation tool, need to be input in succession to the test tool used and to the development tools.

In this case, test tools are generally designed for the needs of a programmer but not for the needs of an operator who would like to engineer an installation automation. Development tools for determining the object data are generally not constructed in an object-oriented manner.

However, the engineering of the automation of a technical installation is still complicated and time-consuming on account of the need to input data to the individual tools, in particular simulation tools, in a multiply redundant manner.

In addition, the manual transfer of data from one tool to another constitutes a source of possible input or transfer errors.

### SUMMARY

According to various embodiments, a method and a system for engineering an automation of at least part of a technical installation having a number N of objects which can be automated can be provided, which method and system are used to avoid these disadvantages.

According to an embodiment, a method for engineering an automation of at least part of a technical installation having a number N of objects which can be automated, may comprise the steps of: a) selecting at least one of the N objects which can be automated in the technical installation; b) determining object data relating to the at least one selected object, which data are needed to automate the at least one selected object; c) determining test conditions for carrying out a test on the at least one selected object on the basis of the object data; and d) simulating at least one test under the test conditions,

steps a) and b) being carried out using at least one development tool, step c) being carried out using at least one test tool and step d) being carried out using at least one simulation tool, and data being transmitted between the at least one development tool, the at least one test tool and the at least one simulation tool using at least one interface.

According to a further embodiment, simulated test results which are generated during a simulated test can be managed using the at least one test tool. According to a further embodiment, at least one simulation protocol can be generated on the basis of simulated test results. According to a further embodiment, at least one simulated test can be carried out for the entire technical installation. According to a further embodiment, further object data can be generated on the basis of the simulated test results, and the further object data being associated with at least one selected object. According to a further embodiment, at least one actual test may also be carried out at least on the at least one selected object under test conditions in a step e) using the at least one test tool. According to a further embodiment, actual test results which are generated during the at least one actual test also can be managed using the at least one test tool. According to a further embodiment, at least one test protocol can be generated on the basis of actual test results. According to a further embodiment, at least one actual test can be carried out for the entire technical installation. According to a further embodiment, at least one test protocol can be generated as part of an FAT protocol for the technical installation.

According to another embodiment, a system for engineering an automation of at least part of a technical installation having a number N of objects which can be automated, in particular for carrying out a method as described above, may comprise —at least one development tool for selecting at least one object which can be automated in the technical installation and for determining object data which are needed to automate the at least one selected object, —at least one test tool for determining test conditions for testing the at least one selected object on the basis of the object data; —at least one simulation tool for simulating at least one test under the test conditions; and —at least one interface which can be used to transmit data between the at least one development tool, the at least one test tool and the at least one simulation tool.

According to a further embodiment, the at least one test tool and the at least one simulation tool can be implemented on a data processing unit. According to a further embodiment, the at least one development tool, the at least one test tool and the at least one simulation tool can be implemented on at least two different data processing units.

According to yet another embodiment, a computer program may carry out a method as described above when executed on a system as described above.

According to yet another embodiment, a computer program product may have a computer program as described above.

### BRIEF DESCRIPTION OF THE DRAWINGS

FIGS. 1 to 4 are intended to explain, by way of example, the processes which previously took place and which take place according to various embodiments when engineering the automation of a technical installation.

FIG. 1 schematically shows a known method and system;

FIG. 2 schematically shows another known method and system;

FIG. 3 schematically shows a method and a system according to various embodiments; and

FIG. 4 schematically shows another method and another system according to various embodiments.

### DETAILED DESCRIPTION

According to various embodiments, the method for engineering an automation of at least part of a technical installation having a number N of objects which can be automated, may comprise the steps of
a) selecting at least one of the N objects which can be automated in the technical installation;
b) determining object data relating to the at least one selected object, which data are needed to automate the at least one selected object;
c) determining test conditions for carrying out a test on the at least one selected object on the basis of the object data; and
d) simulating at least one test under the test conditions,
   steps a) and b) being carried out using at least one development tool, step c) being carried out using at least one test tool and step d) being carried out using at least one simulation tool, and data being transmitted between the at least one development tool, the at least one test tool and the at least one simulation tool using at least one interface.

According to other embodiments, the system for automating at least part of a technical installation having a number N of objects which can be automated, in particular for carrying out the method according to various embodiments, may comprise
at least one development tool for selecting at least one object which can be automated in the technical installation and for determining object data which are needed to automate the at least one selected object,
at least one test tool for determining test conditions for testing the at least one object on the basis of the object data;
at least one simulation tool for simulating at least one test under the test conditions; and
at least one interface which can be used to transmit data between the at least one development tool, the at least one test tool and the at least one simulation tool.

The method and the system according to various embodiments make it possible to engineer an automation of at least part of a technical installation in an uncomplicated and rapid manner using development tools, test tools and simulation tools. Erroneous transfer of data is largely precluded on account of the fact that it is now possible to directly transmit data between all tools involved.

In this case, data can be transmitted between the individual tools in a unidirectional or bidirectional manner.

A computer program for carrying out the method according to other embodiments when executed on a system according to various embodiments is ideal. Such a computer program is provided, in particular, on a computer program product, such as a CD or DVD.

Data are transmitted at least on the basis of the object data. Furthermore, however, other data may also be transmitted via the at least one interface or may be interchanged between the tools, which data relate, for example, to additional information relating to the installation, such as current stock of a component to be processed in the installation, an outside temperature and the like.

Subdivision of the installation into individual objects which can be automated, in which case the properties, requirements, test cases and simulations associated with an object can be linked to the object, makes it possible to engineer the automation of the installation in a particularly rapid and simple manner.

Simulated test results which are generated during a simulated test are preferably managed using the at least one test tool.

At least one simulation protocol is also preferably generated on the basis of the simulated test results.

It may be particularly preferred if at least one simulated test is carried out for the entire technical installation. This enables a specific statement to be made on the automation state of the entire installation.

In particular, further object data can be generated on the basis of the simulated test results, and the further object data can be associated with at least one selected object. The object data are checked, corrected and, if necessary, supplemented on the basis of the at least one simulated test, thus making it possible to detect and avoid errors in the engineering of the automation.

It has proved worthwhile if at least one actual test is also carried out at least on the at least one selected object under test conditions using the at least one test tool. In this case, the actual test can only be carried out if the installation and the control and regulating devices required for the automation are already present and are ready for operation.

In addition to the simulated test results, actual test results which are generated during the at least one actual test are also preferably managed using the at least one test tool. At least one test protocol is preferably generated on the basis of the actual test results. In this case, the test protocol is generated automatically, in particular.

It may be particularly preferred if at least one actual test is carried out for the entire technical installation. This enables a specific statement to be made on the automation state of the entire installation.

At least one test protocol is preferably generated as part of an FAT protocol (FAT=factory acceptance test) or an acceptance protocol which relates to at least part of the technical installation. An FAT is generally still carried out by the installation manufacturer and comprises, in particular, checking the installation to be delivered for completeness and with regard to contractual specifications, proof of function by means of an installation test, checking the documentation for the installation and arranging the dispatch of the installation. In contrast, an acceptance protocol is created by the installation operator after the installation has been delivered.

For the system, it has proved to be advantageous if the at least one development tool, the at least one test tool and the at least one simulation tool are implemented on a data processing unit.

Alternatively, it has likewise proved worthwhile for the system, however, if the at least one development tool, the at least one test tool and the at least one simulation tool are implemented on different data processing units.

In this case, depending on the configuration, different interfaces are needed to transmit data between the tools.

In this case, the at least one interface may be provided in the form of at least one hardware interface and/or at least one software interface. In this case, an XML file or an EXEL file is particularly suitable as a software interface.

The use of a system according to various embodiments to engineer an automation of at least part of a technical installation, in particular a power plant, a continuous casting installation, a rolling train, a papermaking machine, a printing machine and the like, having a number N of objects which can be automated is ideal.

The following example shows the sequence of the method according to various embodiments for an object.

### Example

### Step a)

A power plant is broken down into its objects which can be automated, such as the turbine, evaporator, valve, line etc. In this case, the power plant and its objects which can be automated are represented in a tree diagram, in particular.

### Step b)

The object data relating to the objects are defined. These data include, for example, the requirement that a valve must close within 10 seconds.

### Step c)

The test conditions for a test on the object “valve” on the basis of the object data are determined.

### Step d)

A test for the object “valve” is simulated under the test conditions. This involves, for example, starting the simulated test, actuating the valve (closing) using a motor, saving the simulated test results and checking the simulated test results with regard to whether the valve could be closed within 10 seconds.

### Step e)

An actual test is carried out while actuating the valve, and the actual test results are saved. If the test shows weak points for an object, these weak points are logged and taken over into a list of open points LOP. The list of open points may also record, for each open point, measures and deadlines for eliminating etc. said points.

Traffic light technology is generally used to mark the status of the actual tests carried out for one or more objects: red=test not yet carried out amber=test carried out but still open points green=test carried out without any open points.

The list of open points as well as a status list containing the status of the tests can be generated at any time using the system and can be output using a test protocol.

When the technical installation is being accepted by a customer, an FAT protocol which comprises such a test protocol is created, for example.

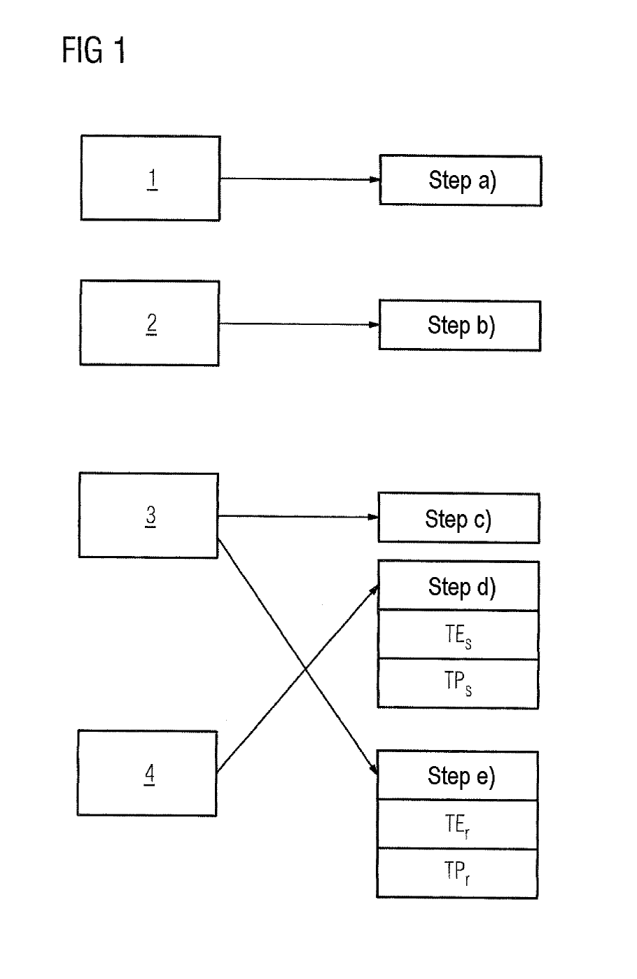

FIG. 1 schematically shows a known method and system for engineering an automation of at least part of a technical installation having a number N of objects which can be automated. There is a first development tool 1 for selecting at least one object which can be automated in the technical installation (step a)) and a second development tool 2 for determining object data which are needed to automate the at least one selected object which can be automated (step b)). There is also a test tool 3 for determining test conditions for testing the object data (step c)) and a simulation tool 4 for carrying out at least one simulated test under the test conditions (step d)).

In this case, the simulated test results TEs are recorded, evaluated and output by the simulation tool 4. Output is effected, in particular, in the form of a simulation protocol TPs.

An actual test (step e)) is optionally also carried out using the test tool 3. In this case, the actual test results TEr are recorded, evaluated and output by the test tool 3. Output is effected, in particular, in the form of a test protocol TPr.

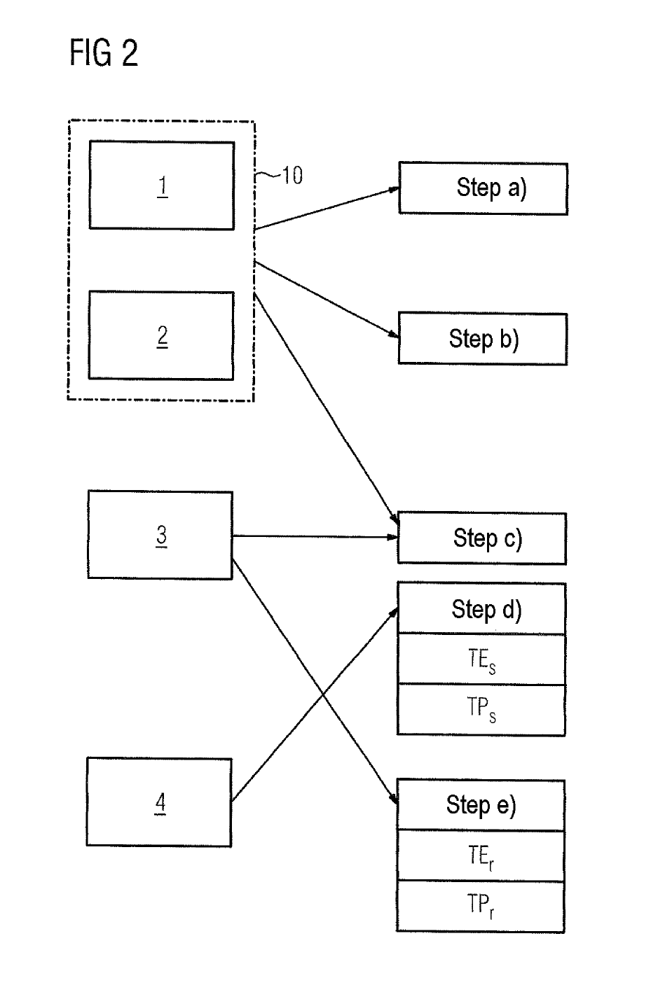

A connection between the individual tools 1, 2, 3, 4 is not provided, with the result that data generated using the latter must be manually transferred from one tool to another. FIG. 2 schematically shows another known method and system similar to FIG. 1. However, an individual development tool is present in this case. Said tool comprises a first development tool 1 for selecting at least one object which can be automated in the technical installation (step a)) and a second development tool 2 for determining object data which are needed to engineer the automation of the at least one selected object which can be automated (step b)). These tools are able to interchange data in this case. The test tool 3 can also already resort to the data from the development tool 10 here.

A connection between the individual tools 10, 3 and the simulation tool 4 is not provided, with the result that data generated using said tools must be manually transferred from the simulation tool 4 to the other tools.

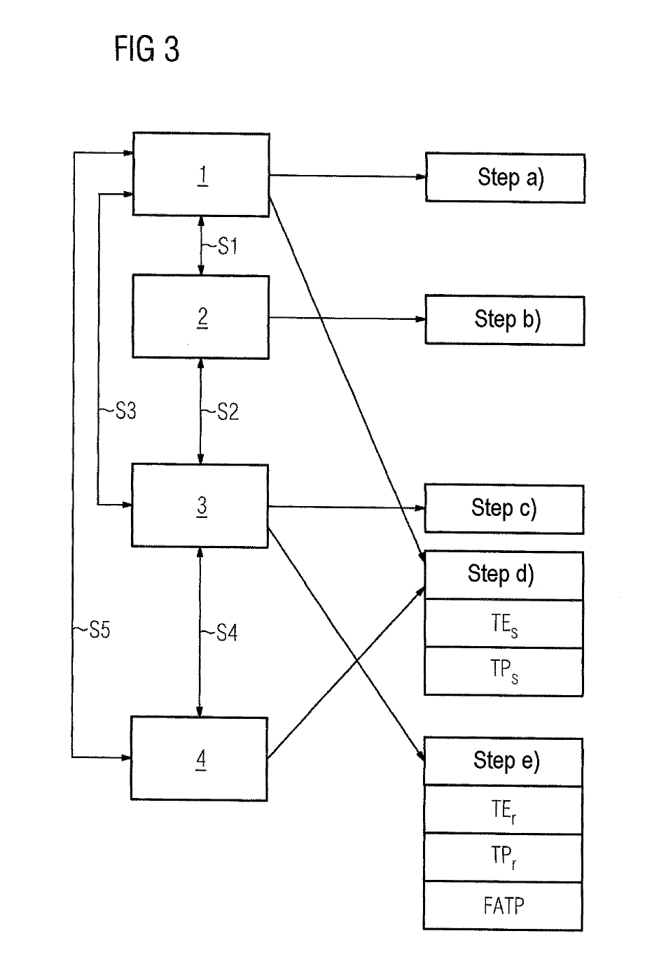

FIG. 3 schematically shows a method and a system according to various embodiments for engineering the automation of at least part of a technical installation having a number N of objects which can be automated. As already shown in FIG. 1, there is a first development tool 1 for selecting at least one object which can be automated in the technical installation (step a)) and a second development tool 2 for determining object data which are needed to engineer the automation of the at least one selected object which can be automated (step b)). There is also a test tool 3 for determining test conditions for testing the object data (step c)) and a simulation tool 4 for carrying out at least one simulated test under the test conditions (step d)). In this case, the simulated test results TEs are recorded, evaluated and output. Output is effected, in particular, in the form of a simulation protocol TPs.

An actual test (step e)) is optionally also carried out using the test tool 3. In this case, the actual test results TEr are recorded, evaluated and output. Output is effected, in particular, in the form of a test protocol TPr.

In contrast to FIG. 1, however, the tools 1, 2, 3, 4 are connected to one another by means of interfaces S1, S2, S3, S4, S5 which make it possible to transmit data. The first development tool 1 and the second development tool 2 are thus connected for data purposes by means of a first interface S1. The test tool 3 is connected to the second development tool 2 for data purposes by means of a second interface S2 and to the first development tool 1 by means of a third interface S3. Alternatively, data can also be transmitted between the test tool 3 and the first development tool 1 via the second interface S2 and the first interface S1, thus making it possible to dispense with the third interface S3. The simulation tool 4 is connected to the test tool 3 for data purposes by means of a fourth interface S4 and to the first development tool 1 by means of a fifth interface S5. Alternatively, data can also be transmitted between the simulation tool 4 and the first development tool 1 via the fourth interface S4, the second interface S2 and the first interface S1, thus making it possible to dispense with the fifth interface S5. As another alternative, data could also be transmitted between the simulation tool 4 and the test tool 3 via the fifth interface S5, the first interface S1 and the second interface S2 or third interface S3, thus making it possible to dispense with the fourth interface S4. Connecting the simulation tool 4 to the first development tool 1 for data purposes makes it possible to associate an object which can be automated with further object data determined in at least one simulated test.

The test protocol TPr is output, in particular, as part of an FAT protocol (FAT=factory acceptance test). In this case, the interfaces S1, S2, S3, S4, S5 are possibly implemented using a respective software interface if the tools 1, 2, 3, 4 are implemented on a data processing device. However, the interfaces S1, S2, S3, S4, S5 are usually implemented using at least one hardware interface and a plurality of software interfaces since at least the development tools 1, 2, the test tool 3 and the simulation tool 4 are often not implemented on a common data processing device.

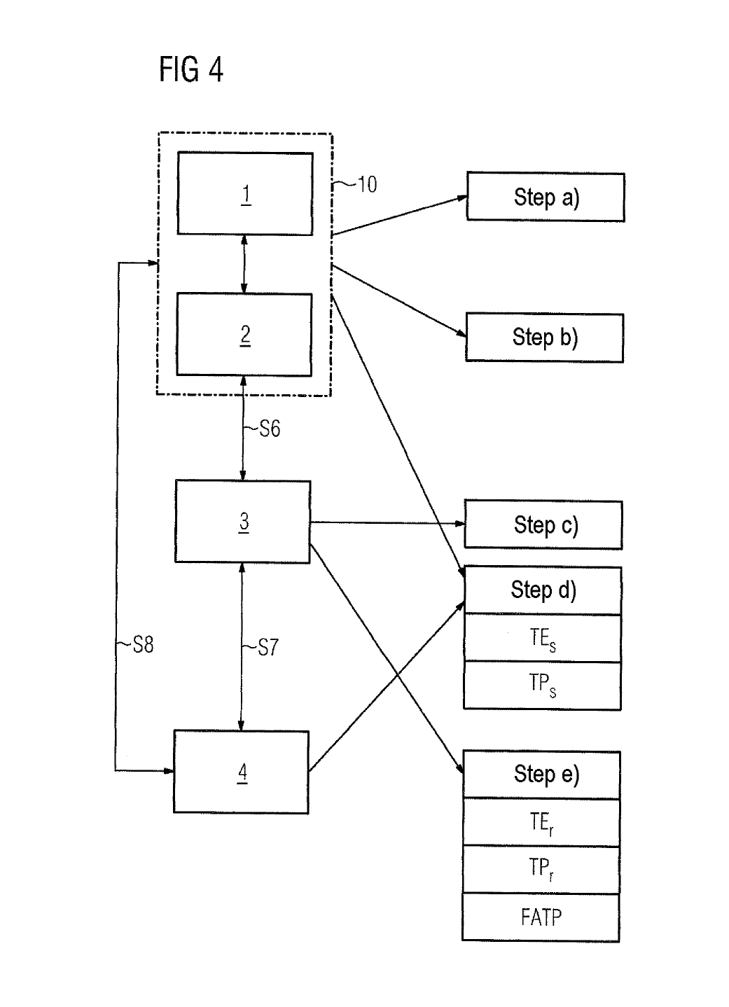

FIG. 4 schematically shows another method and another system according to various embodiments similar to FIG. 3. However, an individual development tool 10 is present in this case, as shown in FIG. 2. Said tool comprises a first development tool 1 for selecting at least one object which can be automated in the technical installation (step a)) and a second development tool 2 for determining object data which are needed to engineer the automation of the at least one selected object which can be automated (step b)). These tools are able to interchange data in this case.

The tools 10, 3, 4 are connected to one another by means of interfaces S6, S7, S8 which make it possible to transmit data. The development tool 10 and the test tool 3 are thus connected for data purposes by means of a sixth interface S6. The simulation tool 4 is connected to the test tool 3 for data purposes by means of a seventh interface S7 and to the development tool 10 by means of an eighth interface S8. Alternatively, data can also be transmitted between the simulation tool 4 and the development tool 10 via the seventh interface S7 and the sixth interface S6, as a result of which there would be no need for an eighth interface S8. In this case too, connecting the simulation tool 4 to the development tool 10 for data purposes makes it possible to associate further object data, which were identified as being required in a simulated test, with a selected object which can be automated.

The test protocol TPr is output as parts of an FAT protocol (FATP=factory acceptance test protocol).

The interfaces S6, S7, S8 are possibly implemented using a respective software interface if the tools 10, 3, 4 are implemented on a data processing device. However, the interfaces S6, S7, S8 are usually implemented using at least one hardware interface and a plurality of software interfaces since the development tool 10, the test tool 3 and the simulation tool 4 are often not implemented on a common data processing device.

The exemplary embodiments according to FIGS. 3 and 4 are only selected by way of example in this case. More than two development tools, a plurality of test tools and a plurality of simulation tools may thus be involved. In this case, it is also possible to dispense with an interface between a simulation tool and a development tool for the purpose of associating further object data with an object which can be automated in the installation if only one object is intended to be simulated and automated.

What is claimed is:

1. A method for engineering an automation of at least part of a technical installation having a number N of objects which can be automated, comprising the steps of:
a) selecting at least one of the N objects which can be automated in the technical installation;
b) determining object data relating to the at least one selected object, which data are needed to automate the at least one selected object;
c) determining test conditions for carrying out a test on the at least one selected object on the basis of the object data; and
d) simulating at least one test under the test conditions,
wherein steps a) and b) being carried out using at least one development tool, step c) being carried out using at least one test tool and step d) being carried out using at least one simulation tool, and data being transmitted between the at least one development tool, the at least one test tool and the at least one simulation tool using at least one interface.

2. The method according to claim 1, wherein simulated test results which are generated during a simulated test being managed using the at least one test tool.

3. The method according to claim 1, wherein at least one simulation protocol being generated on the basis of simulated test results.

4. The method according to claim 1, wherein at least one simulated test being carried out for the entire technical installation.

5. The method according to claim 1, wherein further object data being generated on the basis of the simulated test results, and the further object data being associated with at least one selected object.

6. The method according to claim 1, wherein at least one actual test also being carried out at least on the at least one selected object under test conditions in a step e) using the at least one test tool.

7. The method according to claim 6, wherein actual test results which are generated during the at least one actual test also being managed using the at least one test tool.

8. The method according to claim 6, wherein at least one test protocol being generated on the basis of actual test results.

9. The method according to claim 6, wherein at least one actual test being carried out for the entire technical installation.

10. The method according to claim 8, wherein
at least one test protocol is generated as part of an FAT protocol for the technical installation.

11. A system for engineering an automation of at least part of a technical installation having a number N of objects which can be automated, comprising:
at least one development tool for selecting at least one object which can be automated in the technical installation and for determining object data which are needed to automate the at least one selected object,
at least one test tool for determining test conditions for testing the at least one selected object on the basis of the object data;
at least one simulation tool for simulating at least one test under the test conditions; and
at least one interface which can be used to transmit data between the at least one development tool, the at least one test tool and the at least one simulation tool.

12. The system according to claim 11, wherein the at least one development tool, the at least one test tool and the at least one simulation tool being implemented on a data processing unit.

13. The system according to claim 11, wherein the at least one development tool, the at least one test tool and the at least one simulation tool being implemented on at least two different data processing units.

14. (canceled)

15. A computer program product comprising a computer readable medium storing instructions which when executed on a computer perform the steps of: a) selecting at least one of the N objects which can be automated in the technical installation;
b) determining object data relating to the at least one selected object, which data are needed to automate the at least one selected object;
c) determining test conditions for carrying out a test on the at least one selected object on the basis of the object data; and
d) simulating at least one test under the test conditions;
wherein steps a) and b) being carried out using at least one development tool, step c) being carried out using at least one test tool and step d) being carried out using at least one simulation tool, and data being transmitted between the at least one development tool, the at least one test tool and the at least one simulation tool using at least one interface.

16. The computer program product according to claim 15, wherein simulated test results which are generated during a simulated test being managed using the at least one test tool.

17. The computer program product according to claim 15, wherein at least one simulation protocol being generated on the basis of simulated test results.

18. The computer program product according to claim 15, wherein at least one simulated test being carried out for the entire technical installation.

19. The computer program product according to claim 15, wherein further object data being generated on the basis of the simulated test results, and the further object data being associated with at least one selected object.

20. The computer program product according to claim 15, wherein at least one actual test also being carried out at least on the at least one selected object under test conditions in a step e) using the at least one test tool.
